(19) United States
(12) Patent Application Publication
(10) Pub. No.: US 2026/0051432 A1
(43) Pub. Date: Feb. 19, 2026

(54) COIL COMPONENT

(71) Applicant: TDK Corporation, Tokyo (JP)

(72) Inventors: Kazuya TOBITA, Tokyo (JP); Munehiro TAKAKU, Tokyo (JP); Shinnosuke SUZUKI, Tokyo (JP); Tomohiro KAITO, Tokyo (JP); Tsutomu FUKAI, Tokyo (JP)

(73) Assignee: TDK Corporation, Tokyo (JP)

(21) Appl. No.: 19/296,203

(22) Filed: Aug. 11, 2025

(30) Foreign Application Priority Data
Aug. 13, 2024 (JP) 2024-135050

(51) Int. Cl. H01F 27/00; H01F 5/06; H01F 27/28

(52) U.S. Cl. CPC H01F 27/006; H01F 5/06; H01F 27/2852

(57) ABSTRACT

In the coil component, at least one of the first wiring portion, the second wiring portion, and the pillar portion of the coil conductor includes a divided portion divided into a plurality of paths in parallel along the extending direction. The loss is reduced in the divided portion, so that the coil component having a high self-resonant frequency is realized.

### CROSS-REFERENCE TO RELATED APPLICATIONS

This application is based upon and claims the benefit of priority from Japanese Patent Applications No. 2024-135050, filed on 13 Aug. 2024, the entire content of which is incorporated herein by reference.

### TECHNICAL FIELD

The present disclosure relates to a coil component.

### BACKGROUND

WO2015/022889 discloses a coil component having a parallel portion where coil conductors having the same pattern are stacked and interconnected (connected in parallel) by via conductors.

### SUMMARY

The inventors have repeatedly studied the configuration of the coil component capable of improving the self-resonant frequency (SRF), and newly found the configuration of the coil component capable of realizing a high self-resonant frequency.

According to aspects of the present disclosure, a coil component having an improved self-resonant frequency is provided.

A coil component according to one aspect of the present disclosure includes an element body having a mounting surface, a pair of end surfaces facing each other in a first direction parallel to the mounting surface, and a pair of side surfaces facing each other in a second direction parallel to the mounting surface and orthogonal to the first direction, a pair of terminal electrodes provided on the mounting surfaces of the element body, a coil conductor provided in the element body and including a plurality of first wiring portions and extending parallel to the mounting surface, a plurality of second wiring portions extending parallel to the mounting surface and along the first direction and arranged in parallel in the second direction on a side farther from the mounting surface than the first wiring portions, and a plurality of pairs of pillar portions extending from both end portions of each of the plurality of second wiring portions toward the mounting surface along a third direction orthogonal to the first direction and the second direction, both end portions of the coil conductor extend to the mounting surface and connected to the pair of terminal electrodes. At least one of the first wiring portion, the second wiring portion, and the pillar portion of the coil conductor includes a divided portion divided into a plurality of paths in parallel to an extending direction of the divided portion.

In the coil component, at least one of the first wiring portion, the second wiring portion, and the pillar portion of the coil conductor includes the divided portion, and a high self-resonant frequency is realized by reducing the loss at the divided portion.

### BRIEF DESCRIPTION OF THE DRAWINGS

FIG. 1 is a perspective view of a coil component according to one embodiment.

FIG. 2 is a perspective view of the coil conductor of FIG. 1.

FIG. 3 is an exploded perspective view of the configuration of each layer of the coil component shown in FIG. 1.

FIG. 4 shows a configuration of the wiring portion of the first element layer shown in FIG. 3.

FIG. 5 shows the configuration of the wiring portion of the second element layer shown in FIG. 3.

FIG. 6 shows the configuration of the wiring portion of the third element layer shown in FIG. 3.

FIG. 7 shows the configuration of the wiring portion of the fourth element layer shown in FIG. 3.

FIG. 8 shows the configuration of the wiring portion of the fifth element layer shown in FIG. 3.

FIG. 9 is a flowchart of a procedure of a method for manufacturing the coil component shown in FIG. 1.

FIG. 10 is a side view of the coil component shown in FIG. 1.

FIG. 11 is a perspective view of the configuration of the pillar portion.

FIG. 12 is a perspective view of the coil conductor of the coil component according to a comparative example.

FIG. 13 is a graph showing simulation results of Example and Comparative Example.

FIG. 14 is a perspective view of the pillar portion having a different configuration.

FIG. 15 is a perspective view of the coil conductor having a different configuration.

FIG. 16 shows the configuration of the wiring portion of the second element layer of the coil conductor shown in FIG. 15.

FIG. 17 shows the configuration of the wiring portion of the fourth element layer of the coil conductor shown in FIG. 15.

FIG. 18 is a perspective view of the coil conductor having a different configuration.

FIG. 19 shows the configuration of the wiring portion of the first element layer of the coil conductor shown in FIG. 18.

FIG. 20 shows the configuration of the wiring portion of the third element layer of the coil conductor shown in FIG. 18.

FIG. 21 is a perspective view of the coil conductor having a different configuration.

### DETAILED DESCRIPTION

Hereinafter, embodiments of the present disclosure will be described in detail with reference to the accompanying drawings. In the description of the drawings, the same or corresponding element is denoted by the same reference numeral, and redundant description is omitted.

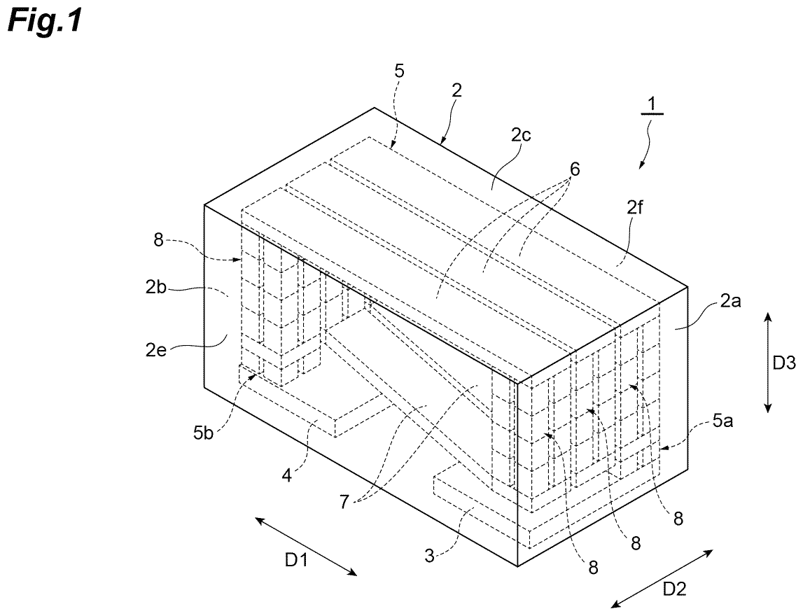

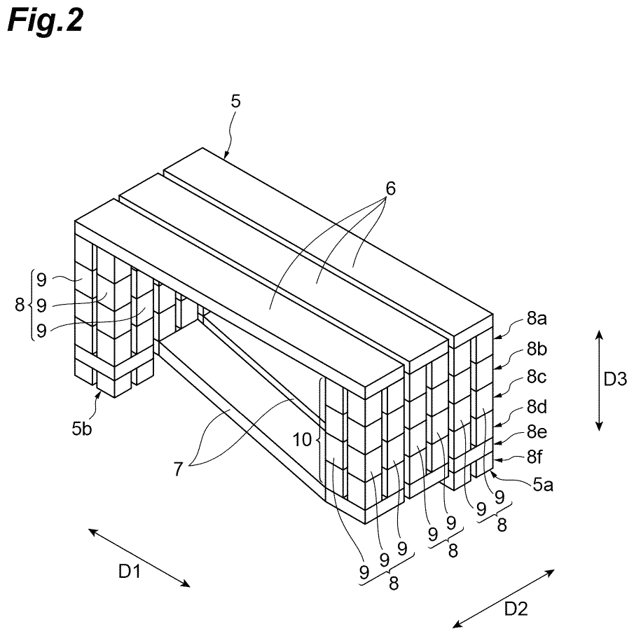

A coil component according to the present embodiment will be described with reference to FIG. 1. As shown in FIGS. 1 and 2, a coil component 1 according to one embodiment includes an element body 2, a pair of bottom electrodes 3 and 4, and a coil conductor 5. The coil conductor 5 is provided in the element body 2 and includes a plurality of second wiring portions 6, a plurality of pairs of pillar portions 8, and a plurality of first wiring portions 7, as will be described later. In particular, the coil conductor 5 includes three of the second wiring portions 6, three pairs of the pillar portions 8, and two of the first wiring portions 7. The coil conductor 5 has a coil axis along a second direction D2 to be described later, and is wound around the coil axis. The coil conductor 5 according to the present embodiment is wound around the coil axis by about 2.5 turns. The number of turns of the coil conductor 5 can be increased or decreased as appropriate. Accordingly, the number of the pairs of pillar portions 8, the number of the first wiring portions 7, and the number of the second wiring portions 6 may be increased or decreased.

The element body 2 has a rectangular parallelepiped shape. The rectangular parallelepiped shape includes a rectangular parallelepiped shape in which a corner portion and a ridge portion are chamfered or rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, the facing direction of the end surfaces 2a and 2b is a first direction D1, the facing direction of the side surfaces 2e and 2f is a second direction D2, and the facing direction of the main surfaces 2c and 2d is a third direction D3. The first direction D1, the third direction D3, and the second direction D2 are substantially orthogonal to each other.

The end surfaces 2a and 2b extend in the third direction D3 to connect the main surfaces 2c and 2d. The end surfaces 2a and 2b also extend in the second direction D2 to connect the side surfaces 2e and 2f. The main surfaces 2c and 2d extend in the first direction D1 to connect the end surfaces 2a and 2b. The main surfaces 2c and 2d also extend in the second direction D2 to connect the side surfaces 2e and 2f. The side surfaces 2e and 2f extend in the first direction D1 to connect the end surfaces 2a and 2b. The side surfaces 2e and 2f also extend in the third direction D3 to connect the main surfaces 2c and 2d.

The main surface 2d is a mounting surface of the element body 2, and is, for example, a surface facing another electronic device when the coil component 1 is mounted on another electronic device (not shown) (for example, a circuit substance or a laminated electronic component). The end surfaces 2a and 2b are continuous surfaces from the mounting surface (i.e., the main surface 2d).

The length of the element body 2 in the first direction D1 is longer than the lengths of the element body 2 in the third direction D3 and the second direction D2. The length of the element body 2 in the third direction D3 is shorter than the length of the element body 2 in the second direction D2. That is, in the present embodiment, each of the end surfaces 2a and 2b, the main surfaces 2c and 2d, and the side surfaces 2e and 2f has a rectangular shape. The length of the element body 2 in the third direction D3 may be comparable with the length of the element body 2 in the second direction D2 or may be longer than the length of the element body 2 in the second direction D2.

In the present embodiment, the term “comparable” may refer to a value including a slight difference or a manufacturing error within a predetermined range, in addition to being equal. For example, when values are included in a range of ±5% of an average value of the values, the values are defined as being comparable.

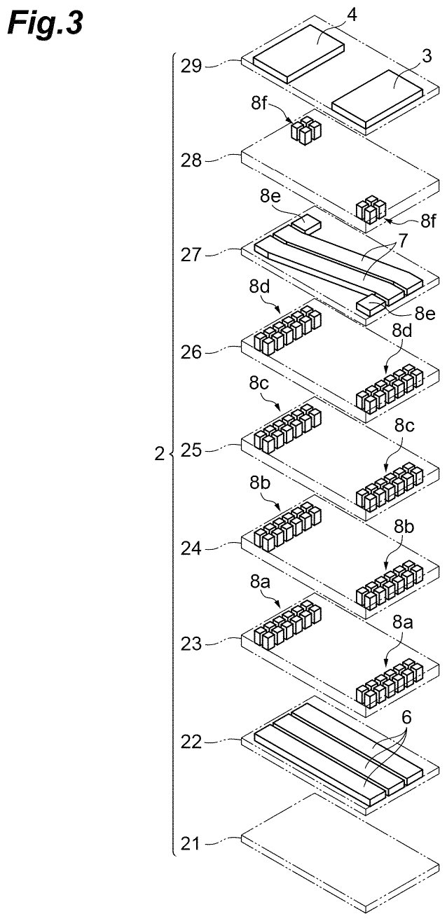

As shown in FIG. 3, the element body 2 has a configuration in which a plurality of element layers are laminated in the third direction D3. In the present embodiment, the element body 2 is composed of nine of element layers 21 to 29. That is, the lamination direction of the element body 2 coincides with the third direction D3. The wiring portions 6 and 7 and wiring portions 8a to 8f constituting the coil conductor 5 are embedded in the element layers 22 to 28. As described in the manufacturing method below, the element body 2 can be manufactured by sequentially laminating the element layers 22 to 29 on the element layer 21. In the actual element body 2, the element layers 21 to 29 may be integrated so that the interface between the layers is visible or not visible to some extent.

Each of the element layers 21 to 29 is mainly composed of insulating material, for example, a resin material. The resin material includes, for example, at least one selected from a liquid crystal polymer, a polyimide resin, a crystalline polystyrene, an epoxy-based resin, an acrylic-based resin, a bismaleimide-based resin, and a fluorine-based resin. The resin material may or may not contain a filler. The filler is, for example, an inorganic filler. The inorganic filler is silica, for example. Each of the element layers 21 to 29 may be made of magnetic material. The magnetic material includes, for example, Ni—Cu—Zn-based ferrite material, Ni—Cu—Zn—Mg-based ferrite material, or Ni—Cu-based ferrite material. The magnetic material may include, for example, Fe alloy. Each of the element layers 21 to 29 may include non-magnetic material, which may be glass-ceramic material or dielectric material. Each of the wiring portions 6, 7, and 8a to 8f is composed of conductive material (for example, Cu).

The element layer 21 is composed only of the insulating material. The element layer 21 is located in the lowest layer of the element body 2 and constitutes the main surface 2c.

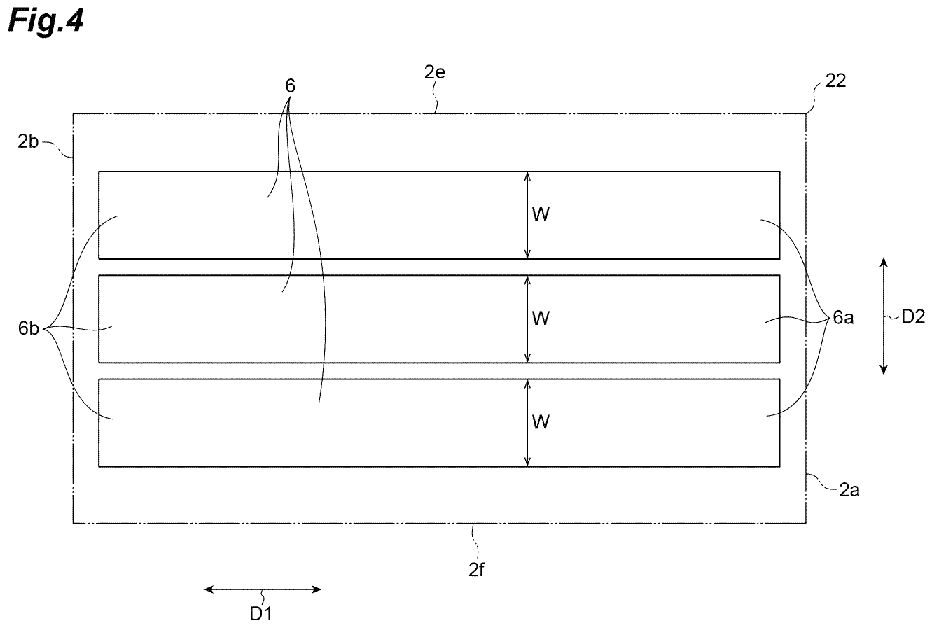

As shown in FIGS. 3 and 4, the second wiring portions 6 (lower wiring portions) are embedded in the element layer 22, and the element layer 22 according to the present embodiment includes three of the second wiring portions 6. Each of the second wiring portions 6 extends in parallel along the first direction D1 and has the same length with respect to the first direction D1. In the present embodiment, the second wiring portions 6 have the same length (width W) with respect to the second direction D2. The second wiring portions 6 are equally spaced with respect to the second direction D2. The second wiring portions 6 are spaced apart from the end surfaces 2a and 2b and the side surfaces 2e and 2f of the element body 2. One end portion 6a in the extending direction of each of the second wiring portions 6 is located near the end surface 2a, and the other end portion 6b is located near the end surface 2b. The second wiring portions 6 are located closer to the main surface 2c of the element body 2 because the element layer 22 is laminated directly on the element layer 21 constituting the main surface 2c. Hereinafter, the element layer 22 is also referred to as a first element layer.

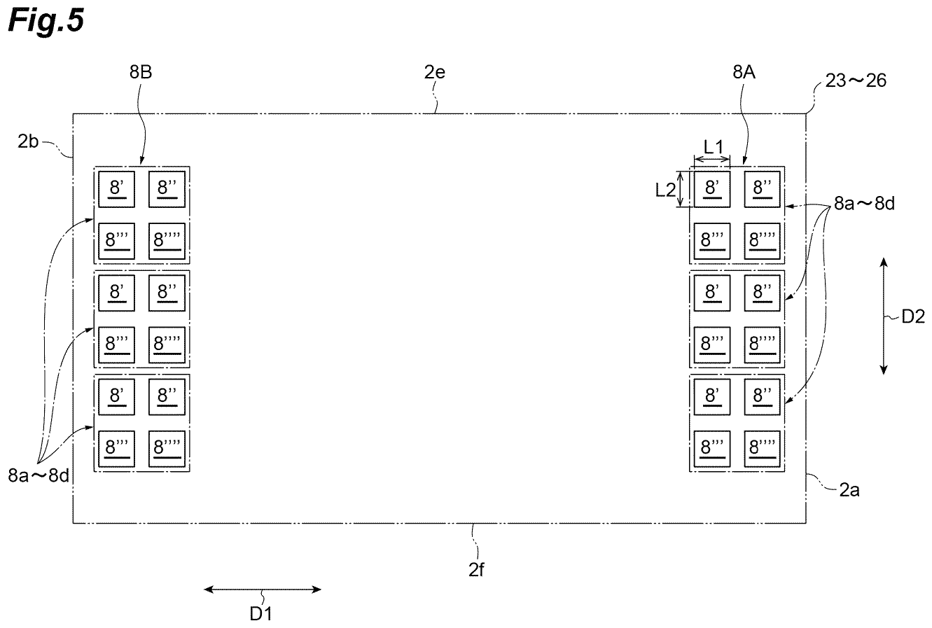

In the element layers 23 to 26, as shown in FIGS. 3 and 5, the wiring portions 8a to 8d (pillar conductors) constituting the pillar portion 8 extending along the third direction D3 are embedded. The wiring portions 8a to 8d are provided at the same position in each of the element layers 23 to 26 and overlap each other in the third direction D3. Hereinafter, the element layers 23 to 26 are also referred to as second element layers.

Each of the wiring portions 8a to 8d is composed of a plurality of pairs with respect to the first direction D1, and is composed of three pairs in the present embodiment. In particular, each of the wiring portions 8a to 8d is aligned in two rows along the second direction D2 and are equally spaced with respect to the second direction D2. Hereinafter, of the wiring portions 8a to 8d aligned in two rows, the row on the end surface 2a side is also referred to as a first row 8A and the row on the end surface 2b side is also referred to as a second row 8B. The wiring portions 8a to 8d at the first row 8A are arranged at positions corresponding to the end portion 6a of the second wiring portions 6, and the wiring portions 8a to 8d at the second row 8B is arranged at positions corresponding to the end portions 6b of the second wiring portions 6.

In the present embodiment, each of the wiring portions 8a to 8d is composed of a plurality of conductors. In particular, each of the wiring portions 8a to 8d is composed of four conductors 8′, 8″, 8′″, and 8″″ aligned in a matrix along the first direction D1 and the second direction D2. Each of the conductors 8′, 8″, 8′″, and 8″″ may be generally rectangular (for example, generally square) when viewed from the third direction D3. Each of the conductors 8′, 8″, 8′″, and 8″″ may have a circular shape, an elliptical shape, or a polygonal shape other than a square shape when viewed from the third direction D3.

As for dimensions, each of the wiring portions 8a to 8d having a rectangular shape when viewed from the third direction D3 has a first direction length and a second direction length comparable to the width W of the second wiring portion 6. Four of the conductors 8′, 8″, 8′″, and 8″″ have the same first direction length L1 and the same second direction length L2, and both the first direction length L1 and the second direction length L2 are less than half of the width of the second wiring portion 6 (L1<W/2, L2<W/2).

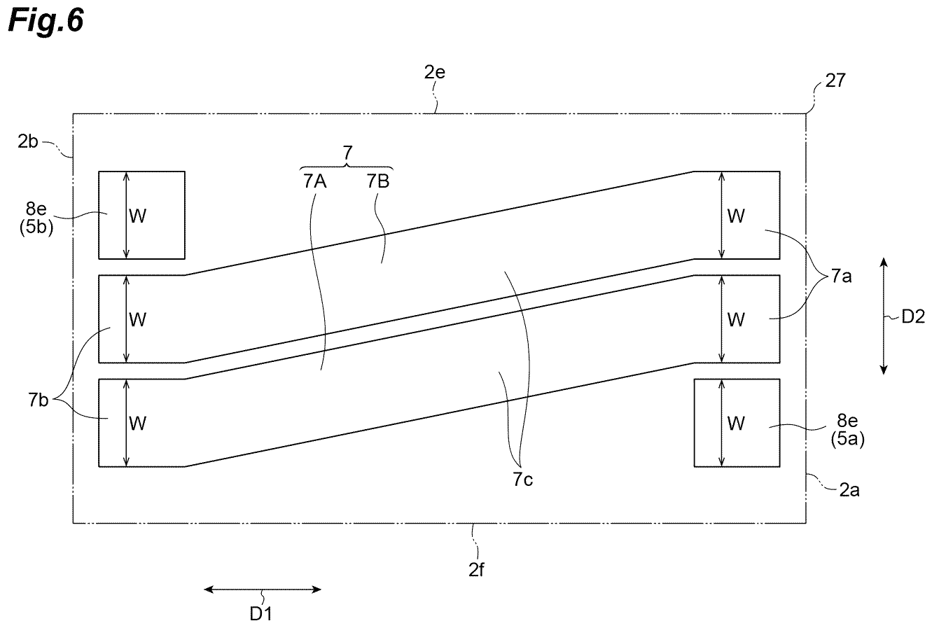

In the element layer 27, as shown in FIGS. 3 and 6, a plurality of the first wiring portions 7 are embedded, and the element layer 27 includes two of the first wiring portions 7 in the present embodiment. Hereinafter, the element layer 27 is also referred to as a third element layer. Each of the first wiring portions 7 has a pair of end portions 7a and 7b and an inclined portion 7c interposed between the pair of the end portions 7a and 7b. The pair of the end portions 7a and 7b, and the inclined portion 7c are configured to be continued, and the pair of the end portions 7a and 7b are located on both sides of the inclined portion 7c with respect to the first direction D1. The pair of the end portions 7a and 7b are composed of a first end portion 7a located closer to the end surface 2a of the element body 2, and a second end portion 7b located closer to the end surface 2b of the element body 2. The pair of the end portions 7a and 7b are offset from each other with respect to the second direction D2 when viewed from the third direction D3. In the present embodiment, the first end portion 7a is located closer to the side surface 2f than the second end portion 7b when viewed from the third direction D3. The inclined portion 7c extends in a direction inclined at a predetermined angle with respect to the first direction D1 and connects the pair of the end portions 7a and 7b offset from each other with respect to the second direction D2. The inclined angle with respect to the first direction D1 is the same for all the first wiring portions 7. That is, the inclined portions 7c in the first wiring portions 7 have a parallel relationship with each other.

The first end portion 7a of the first wiring portion 7 overlaps with one of the end portions 6a of the second wiring portions 6 and one of the wiring portions 8a to 8d at the first row 8A when viewed from the third direction D3. The second end portion 7b of the first wiring portion 7 overlaps with one of the end portions 6b of the second wiring portions 6 and one of the wiring portions 8a to 8d at the second row 8B when viewed from the third direction D3. In the present embodiment, both the first end portion 7a and the second end portion 7b of the first wiring portion 7 have the second direction length same as the width W of the second wiring portion 6. In the present embodiment, the second end portion 7b of the first wiring portion 7A of two of the first wiring portions 7 overlaps with the first of the wiring portions 8a to 8d counted from the side surface 2f side of the wiring portions 8a to 8d at the second row 8B and overlaps with the end portion 6b of the first of the second wiring portions 6 counted from the side surface 2f side, and the first end portion 7a overlaps with the second of the wiring portions 8a to 8d counted from the side surface 2f side of the wiring portions 8a to 8d at the first row 8A and overlaps with the end portion 6a of the second of the second wiring portion 6 counted from the side surface 2f side. Similarly, the second end portion 7b of the first wiring portion 7B of two of the first wiring portions 7 overlaps with the second of the wiring portions 8a to 8d counted from the side surface 2f side of the wiring portions 8a to 8d at the second row 8B and overlaps with the end portion 6b of the second of the second wiring portions 6 counted from the side surface 2f side, and the first end portion 7a overlaps with the third of the wiring portions 8a to 8d counted from the side surface 2f side of the wiring portions 8a to 8d at the first row 8A and overlaps with the end portion 6a of the third of the second wiring portions 6 counted from the side surface 2f side.

In addition, a pair of the wiring portions 8e (first extracting wiring portions) are embedded in the element layer 27. One of the wiring portions 8e is provided at a position overlapping with one of the wiring portions 8a to 8d at the first row 8A, and the other of the wiring portions 8e is provided at a position overlapping with one of the wiring portions 8a to 8d at the second row 8B. In the present embodiment, one of the wiring portions 8e overlaps with the first of the wiring portions 8a to 8d counted from the side surface 2f side of the wiring portions 8a to 8d at the first row 8A and overlaps with the end portion 6a of the first of the second wiring portions 6 counted from the side surface 2f side, thereby constituting an end portion 5a of the coil conductor 5. The other of the wiring portions 8e overlaps with the third of the wiring portions 8a to 8d counted from the side surface 2f side of the wiring portions 8a to 8d at the second row 8B and overlaps with the end portion 6b of the third of the second wiring portions 6 counted from the side surface 2f side, thereby constituting an end portion 5b of the coil conductor 5. Each of the wiring portions 8e having a rectangular shape when viewed from the third direction D3 has a first direction length and a second direction length comparable with the width W of the second wiring portion 6.

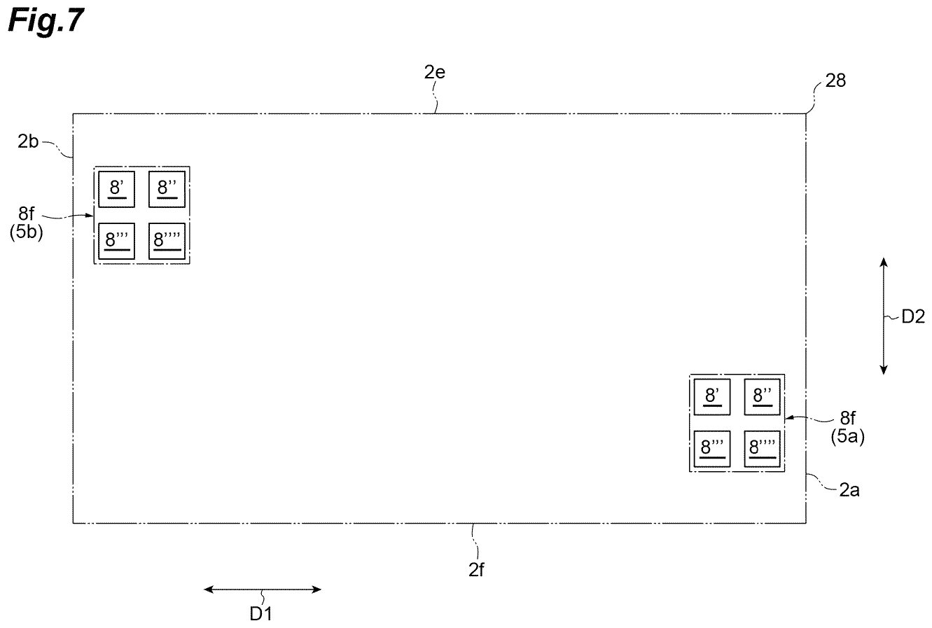

As shown in FIGS. 3 and 7, a pair of wiring portions 8f (second extracting wiring portions) are embedded in the element layer 28. The pair of the wiring portions 8f are provided at positions overlapping with the pair of the wiring portions 8e of the element layer 27, respectively. Of the pair of the wiring portions 8f, the wiring portion 8f on the end surface 2a side and the side surface 2f side constitutes the end portion 5a of the coil conductor 5, and the wiring portion 8f on the end surface 2b side and the side surface 2e side constitutes the end portion 5b of the coil conductor 5. Hereinafter, the element layer 28 is also referred to as a fourth element layer.

Each of the wiring portions 8f having a rectangular shape when viewed from the third direction D3 has a first direction length and a second direction length comparable with the width W of the second wiring portion 6. In the present embodiment, each of the wiring portions 8f is composed of a plurality of conductors. In particular, each of the wiring portions 8f is, same as the wiring portion 8a to 8d, composed of four conductors 8′, 8″, 8′″, and 8″″ aligned in a matrix along the first direction D1 and the second direction D2.

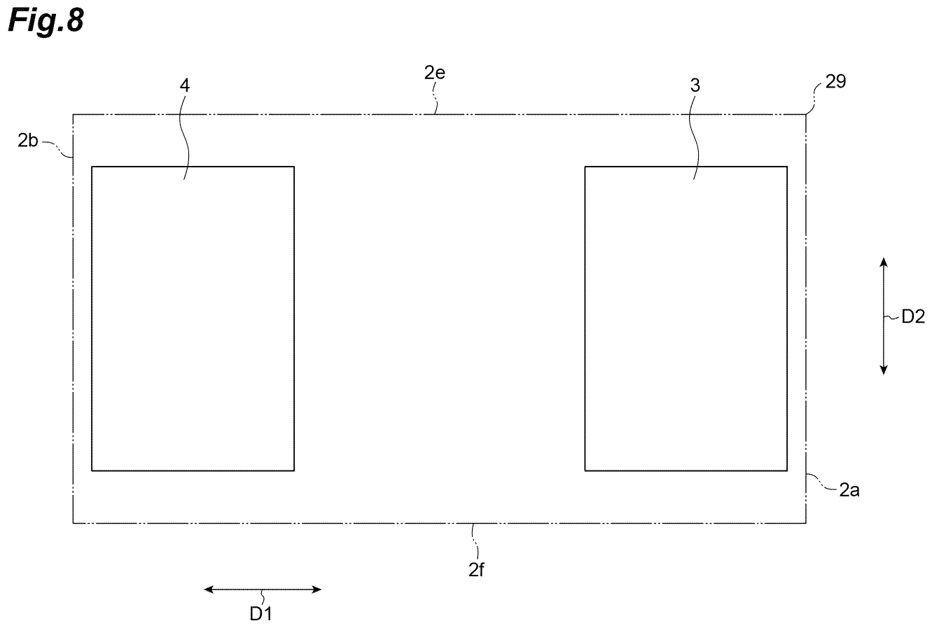

As shown in FIGS. 3 and 8, the element layer 29 is provided with a pair of the bottom electrodes 3 and 4 (terminal electrodes). The element layer 29 is located at the top of the element body 2 in view of the manufacturing procedure, and the element layer 29 constitutes the main surface 2d. In other words, the pair of the bottom electrodes 3 and 4 are provided in the main surface 2d of the element body 2. Hereinafter, the element layer 29 is also referred to as a fifth element layer. Each of the bottom electrodes 3 and 4 has a rectangular shape when viewed from the third direction D3. The bottom electrodes 3 and 4 may have the same shape and the same dimensions. The bottom electrodes 3 and 4 according to the present embodiment are arranged in the first direction D1, the bottom electrode 3 located closer to the end surface 2a of the element body 2 overlaps with the wiring portion 8f in the element layer 28 closer to the end surface 2a and the side surface 2f, and the bottom electrode 4 located closer to the end surface 2b of the element body 2 overlaps with the wiring portion 8f in the element layer 28 closer to the end surface 2b and the side surface 2e. The bottom electrodes 3 and 4 are embedded in the element body 2 (more specifically, inside the element layer 29) and are exposed from the main surface 2d. A part or a whole of the bottom electrodes 3 and 4 may be provided on the main surface 2d of the element body 2.

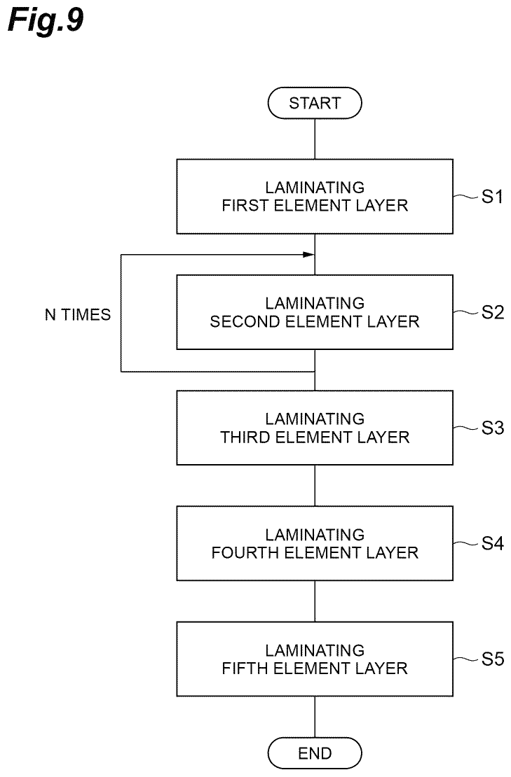

The coil component 1 can be manufactured by the manufacturing method shown in the flowchart of FIG. 9.

First, the element layer 21 and the first element layer 22 are prepared as a first step S1. In the first step S1, the first element layer 22 is laminated on the element layer 21. Alternatively, the element layer 21a on which the first element layer 22 is laminated in advance may be prepared.

Next, as a second step S2, the second element layers 23 to 26 are sequentially laminated on the first element layer 22. When the second element layers 23 to 26 are composed of a plurality of layers as in the present embodiment, the second step S2 is repeated a plurality of times. That is, when the number of the second element layers is N, the second step S2 is repeated N times. When the second element layer is a single layer, the second step S2 is performed only once and does not need to be repeated.

Thereafter, as a third step S3, the third element layer 27 is laminated on the second element layers 23 to 26 (specifically, on the second element layer 26 located at the uppermost position). Further, as a fourth step S4, the fourth element layer 28 is laminated on the third element layer 27. Finally, as a fifth step S5, the fifth element layer 29 is laminated on the fourth element layer 28. The bottom electrodes 3 and 4 may be provided on the fifth element layer 29 before the fifth element layer 29 is laminated, or may be provided on the fifth element layer 29 after the fifth element layer 29 is laminated.

Next, the pillar portion 8 according to the present embodiment will be described with reference to FIGS. 1, 2, and 10.

In the present embodiment, the pillar portion 8 is formed by stacking the wiring portions 8a to 8d of each of the element layers 23 to 26. The pillar portion 8 is composed of a plurality of pairs along the first direction D1, and is composed of three pairs in the present embodiment. Three pairs of the pillar portions 8 are aligned in two rows of the first row 8A and the second row 8B along the second direction D2, same as the wiring portions 8a to 8d.

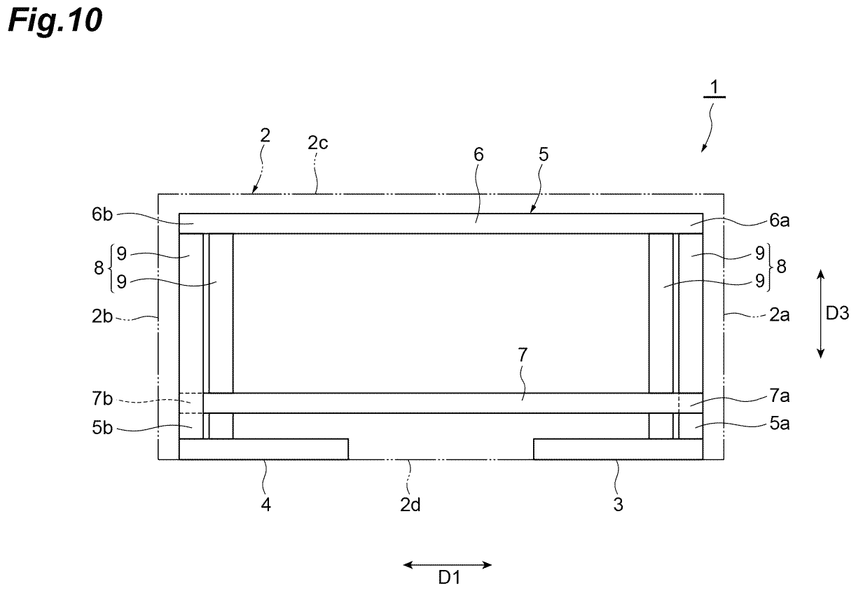

As shown in FIG. 10, each of the pillar portions 8 is connected to both of the end portions 6a and 6b of the second wiring portion 6. In particular, the end portion 6a of the second wiring portion 6 is connected to one end portion of the pillar portion 8 (end portion on the main surface 2c side), and the end portion 6b of the second wiring portion 6 is also connected to one end portion of the pillar portion 8 (end portion on the main surface 2c side). Each of the pillar portions 8 extends from both of the end portions 6a and 6b of the second wiring portion 6 toward the main surface 2d of the element body 2. In other words, one of the second wiring portions 6 is bridged between two of the pillar portions 8.

In the present embodiment, in the first pillar portion 8 at the first row 8A counted from the side surface 2f side, one end portion is connected to the end portion 6a of the first of the second wiring portion 6 counted from the side surface 2f side, and the other end portion is connected to the bottom electrode 3 provided in the main surface 2d via the wiring portions 8e and 8f constituting the end portion 5a of the coil conductor 5. In the second pillar portion 8 and the third pillar portion 8 at the first row 8A counted from the side surface 2f side, one end portion is respectively connected to the end portion 6a of the second and the third of the second wiring portions 6 counted from the side surface 2f side, and the other end portion is respectively connected to the first end portion 7a of the first and the second of the first wiring portions 7 counted from the side surface 2f side.

In addition, in the present embodiment, in the first and the second of the pillar portion 8 at the second row 8B counted from the side surface 2f side, one end portion is respectively connected to the end portion 6b of the first and the second of the second wiring portion 6 counted from the side surface 2f side, and the other end portion is respectively connected to the second end portion 7b of the first and the second of the first wiring portion 7 counted from the side surface 2f side. In the third of the pillar portion 8 at the second row 8B counted from the side surface 2f side, one end portion is connected to the end portion 6b of the third of the second wiring portion 6 counted from the side surface 2f, and the other end portion is connected to the bottom electrode 4 provided in the main surface 2d via the wiring portions 8e and 8f constituting the end portion 5b of the coil conductor 5.

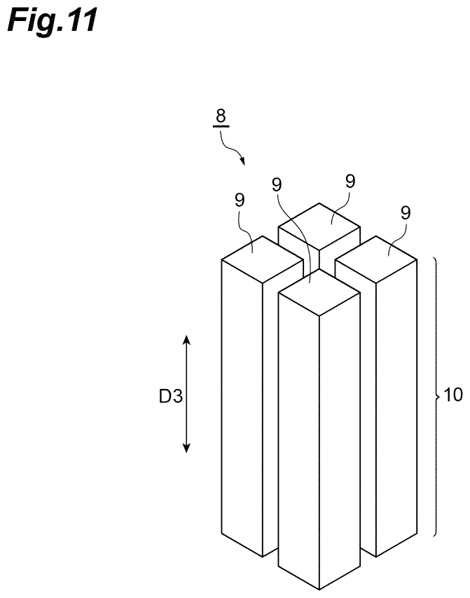

Here, since each of the wiring portions 8a to 8d is composed of four conductors 8′, 8″, 8′″, and 8″″, as shown in FIG. 11, each of the pillar portions 8 is composed of four divided pillars 9 formed by stacking four of the conductors 8′, 8″, 8′″, and 8″″. Four of the divided pillars 9 have the same length (third direction length), and one end portion is connected to the end portion 6a or 6b of the second wiring portion 6, and the other end portion is connected to the end portions 7a or 7b of the first wiring portion 7 or the wiring portion 8e. That is, each of the pillar portions 8 is divided into four along the entire length by four divided pillars 9 in parallel along the third direction D3. In other words, the whole of each of the pillar portions 8 is a divided portion 10 divided into four in parallel along the extending direction (the third direction D3).

When the coil component 1 is applied to a radio frequency circuit, an AC resistance (loss) may occur in the coil conductor 5 due to the skin effect and the proximity effect. In the divided portion 10 in the pillar portion 8, the AC resistance is reduced by divided paths, so that the loss of the coil conductor 5 is suppressed, thereby improving the self-resonant frequency in the coil component 1.

The inventors performed the following simulation regarding the self-resonant frequency of the coil component 1.

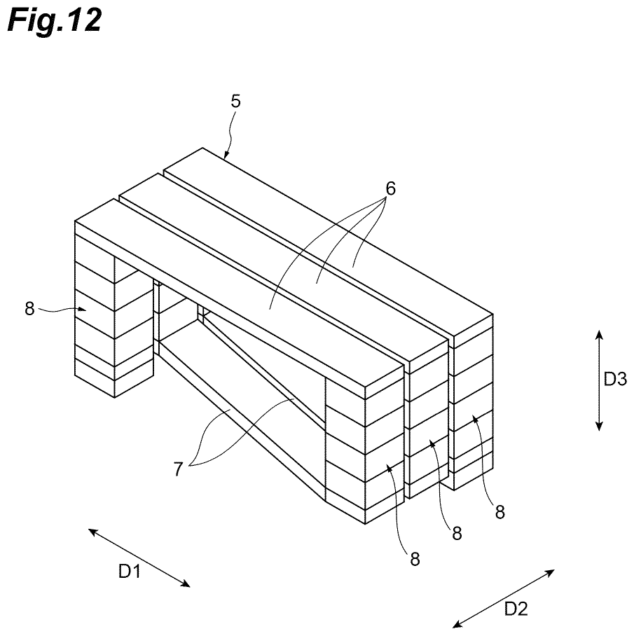

A coil component having the configuration of the above coil component 1 was prepared as an example, and a coil component as shown in FIG. 12 was prepared as a comparative example, which includes a coil conductor same as the coil conductor 5 of the above coil component 1 except that each of the pillar portions 8 is not divided.

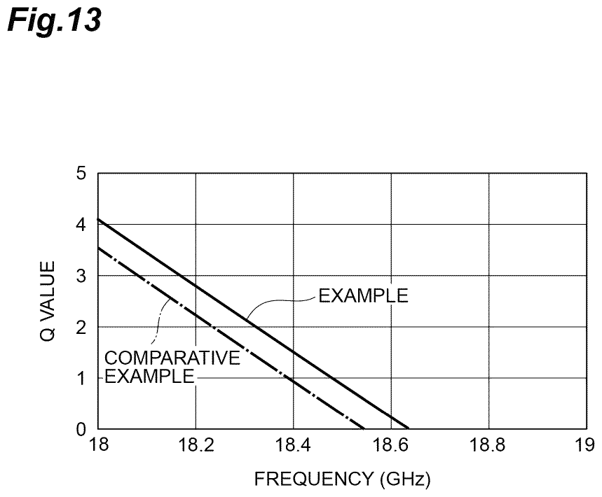

Then, by means of simulation, the self-resonant frequency of the example and the comparative example was measured. The simulation was performed using Ansys HFSS (3D electromagnetic simulation software) by ANSYS, Inc., and the results are shown in FIG. 13.

According to the results, it was found that the self-resonant frequency of the example is higher than that of the comparative example. That is, it was confirmed that the self-resonant frequency of the coil component 1 is improved when the pillar portion 8 includes the divided portion 10.

As described above, in the coil component 1, the whole of the pillar portion 8 of the coil conductor 5 is the divided portion 10, and a high self-resonant frequency is realized by reducing the loss at the divided portion 10.

In addition, in a case where conductors (via conductors or the like) extending in a direction along the coil axis (i.e., the second direction D2) is included in the coil conductor 5, the direction of the current is greatly changed at such conductors, thereby increasing the electric resistance, but in the coil component 1, since the coil conductor 5 has a seamless winding structure that does not include conductors extending in a direction along the coil axis (i.e., the second direction D2), the AC resistance (loss) is further reduced.

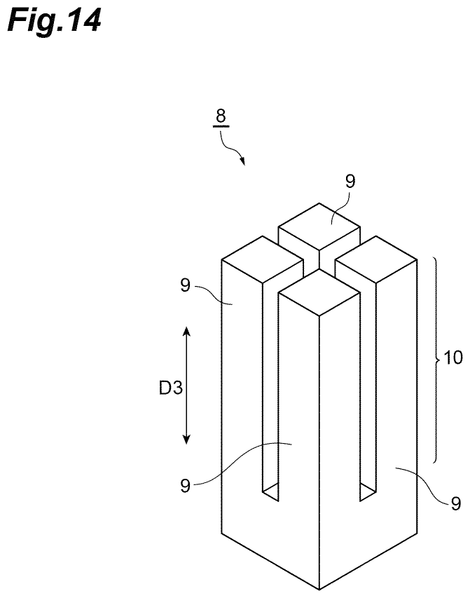

The whole of the pillar portion 8 may be the divided portion 10 as described above, or the pillar portion 8 may include the divided portion 10 divided partially along the extending direction (the third direction D3) as shown in FIG. 14. In the pillar portion 8 shown in FIG. 14, the divided portion 10 is provided on one end portion side that is connected to the end portions 6a and 6b of the second wiring portion 6, and the wiring portion 8e is not divided on the other end portion side that is connected to the end portions 7a and 7b of the first wiring portion 7. The pillar portion 8 shown in FIG. 14 may be formed by configuring the wiring portions 8a to 8c including four of the conductors 8′, 8″, 8′″, and 8″″ and the wiring portion 8d with one conductor that is not divided.

In addition, the divided portion is not necessarily included in the pillar portion 8 as long as it is included in the coil conductor 5, and may be included in the first wiring portion 7 or the second wiring portion 6. The divided portion 10 may be included only in the pillar portion 8, the divided portion 10 may be included only in the first wiring portion 7, or the divided portion 10 may be included only in the second wiring portion 6. The divided portion 10 may be included in a plurality of portions (for example, two portions) of the pillar portion 8, the first wiring portion 7, and the second wiring portion 6. The divided portion 10 may be included in all portions of the pillar portion 8, the first wiring portion 7, and the second wiring portion 6, and the coil conductor 5 may be divided as a whole. The divided portion 10 may be included in all of the pillar portion 8 (for example, all of three pairs), or the divided portion 10 may be included in a part of the pillar portions 8 (for example, one or one pair). Similarly, the divided portion 10 may be included in all of the first wiring portion 7 and the second wiring portion 6, or the divided portion 10 may be included in a part of the first wiring portion 7 and the second wiring portion 6. The number of divided paths in the divided portion is not limited to four, and may be increased or decreased as appropriate.

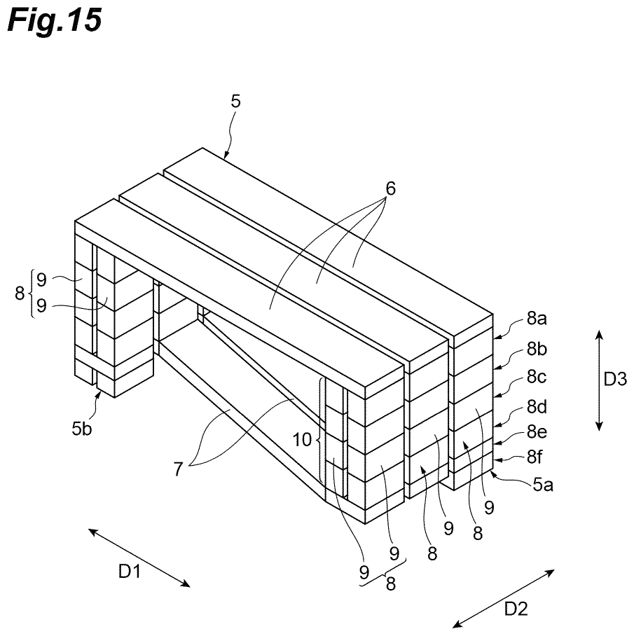

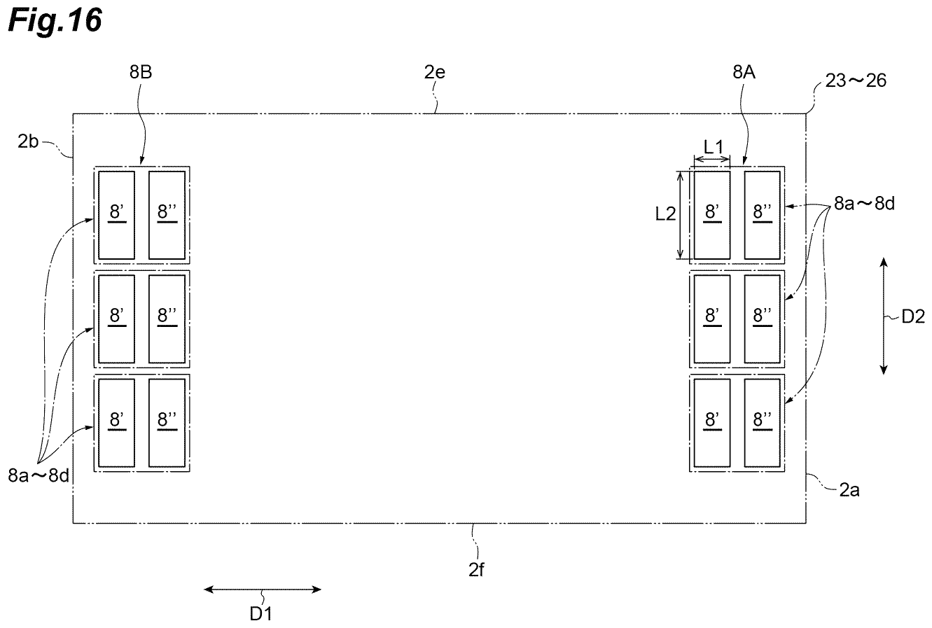

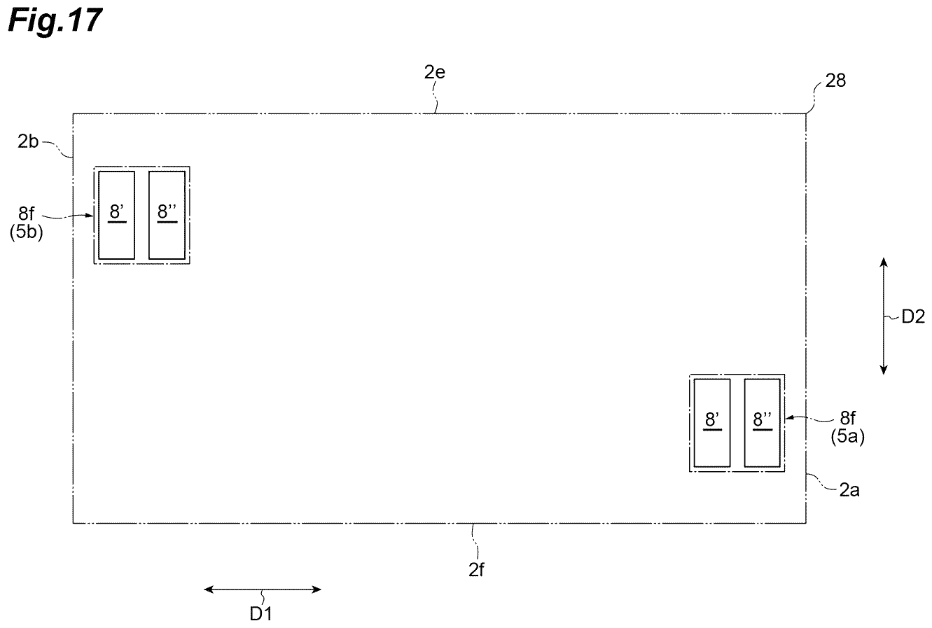

FIG. 15 shows a perspective view of the coil conductor 5 in which the number of divided paths in the divided portion 10 of the pillar portion 8 is two. The coil conductor 5 shown in FIG. 15 has a configuration comparable with that of the above-described coil conductor 5 except for the wiring portion 8a to 8d in the second element layers 23 to 26 and the wiring portion 8f in the fourth element layer 28. In particular, each of the wiring portions 8a to 8d, and 8f, is composed of one pair of the rectangular conductors 8′ and 8″, extending in the second direction D2 and aligned in the first direction D1, as shown in FIGS. 16 and 17. Each of the conductors 8′ and 8″ may have a circular shape, an elliptical shape, or a polygonal shape other than a square shape when viewed from the third direction D3.

The pair of the conductors 8′ and 8″ has the same first direction length L1 and the same second direction length L2. The first direction length L1 is less than half of the width W of the second wiring portion 6 (L1<W/2) and the second direction length L2 is comparable with or less than the width W of the second wiring portion 6 (L2≤W).

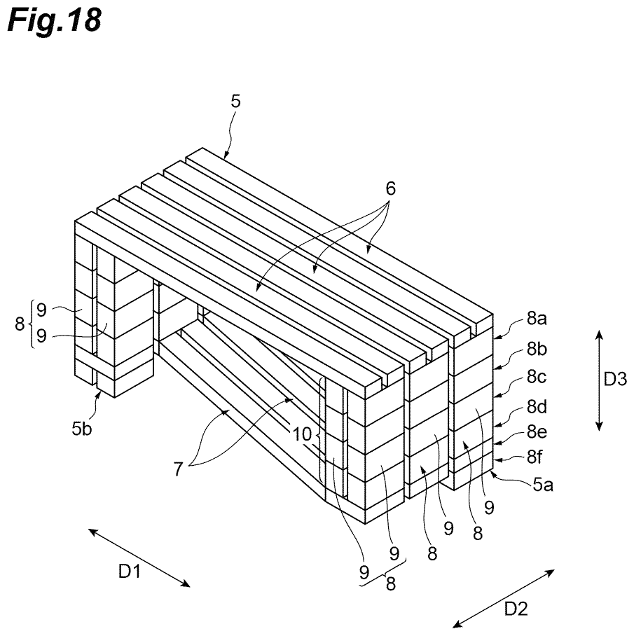

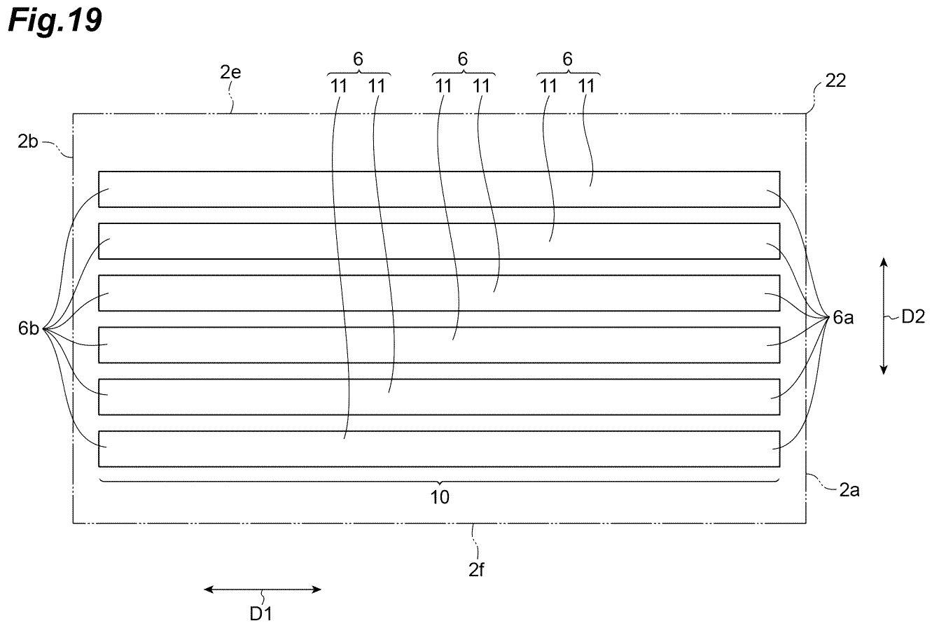

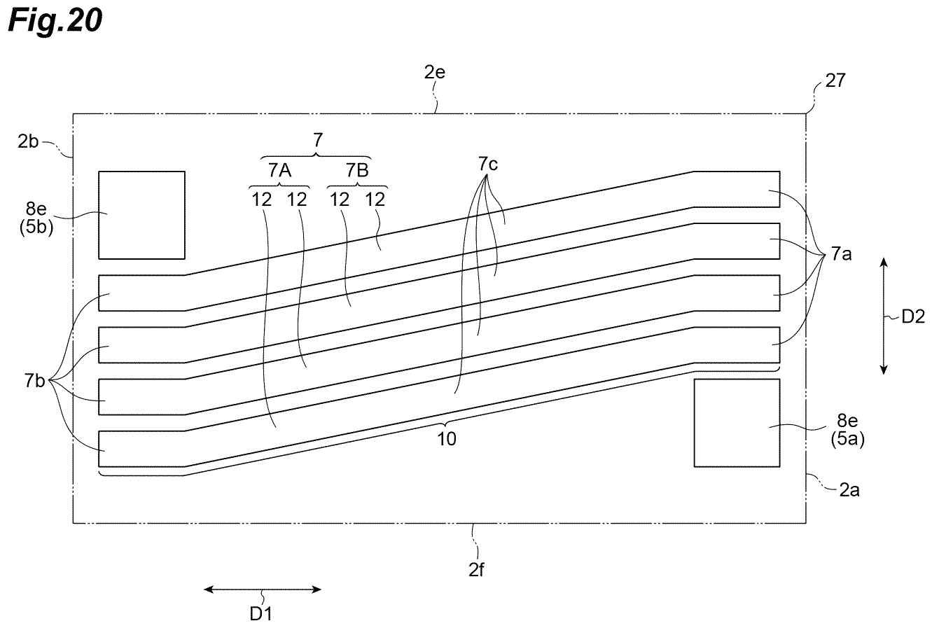

FIG. 18 shows a perspective view of the coil conductor 5 where the first wiring portion 7 and the second wiring portion 6 in the coil conductor 5 shown in in FIG. 15 are further divided. The coil conductor 5 shown in FIG. 18 has a configuration comparable with that of the coil conductor 5 shown in FIG. 15 except for the wiring portion 8a to 8d in the second element layers 23 to 26 and the wiring portion 8f in the fourth element layer 28. In particular, each of the second wiring portions 6 is divided into two along the entire length by two divided wiring 11 parallel along the first direction D1, as shown in FIG. 19. In other words, the whole of each of the second wiring portions 6 is the divided portion 10 divided into two in parallel along the extending direction (the first direction D1). Similarly, each of the first wiring portions 7 is divided into two along the entire length by two divided wiring 12 in parallel, as shown in FIG. 20. In other words, the whole of each of the first wiring portions 7 is the divided portion 10 divided into two in parallel along the extending direction. In the coil conductor 5 shown in FIG. 18, the number of divided paths of “2” in the divided portion 10 of the pillar portion 8 is the same as the number of divided paths of “2” in the divided portion 10 of the second wiring portion 6 and the first wiring portion 7.

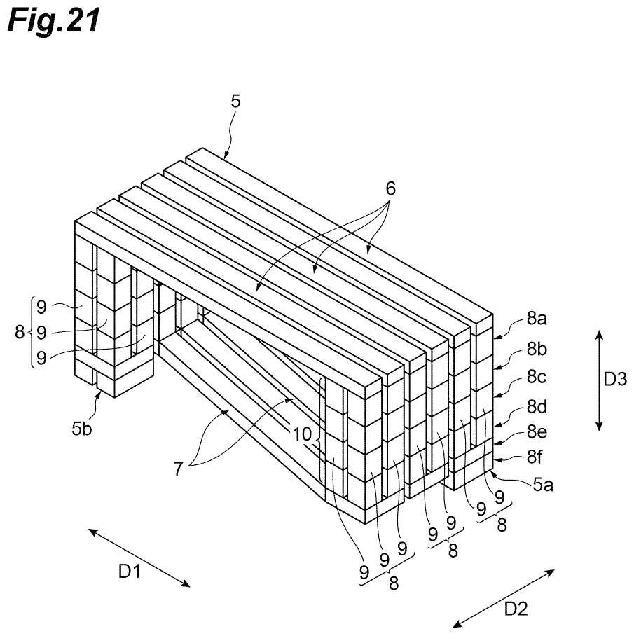

In the coil conductor 5 shown in FIG. 18, the divided portion 10 of the pillar portion 8 may be changed. For example, by adopting the wiring portions 8a to 8d and 8f composed of four of the conductors 8′, 8″, 8′″, and 8″″ as shown in FIGS. 5 and 7, the number of divided paths in the divided portion 10 of the pillar portion 8 of the coil conductor 5 shown in FIG. 18 can be increased to “4” as in the coil conductor 5 shown in FIG. 21. In the coil conductor 5 shown in FIG. 21, the number of divided paths in the divided portion 10 of the pillar portion 8 is different from the number of divided paths in the divided portion 10 of the second wiring portion 6 and the first wiring portion 7, and the number of divided paths of “4” in the divided portion 10 of the pillar portion 8 is larger than the number of divided paths of “2” in the divided portion 10 of the second wiring portion 6 and the first wiring portion 7.

What is claimed is:

1. A coil component comprising:
an element body having a mounting surface, a pair of end surfaces facing each other in a first direction parallel to the mounting surface, and a pair of side surfaces facing each other in a second direction parallel to the mounting surface and orthogonal to the first direction;
a pair of terminal electrodes provided on the mounting surface of the element body; and
a coil conductor provided in the element body and including a plurality of first wiring portions and extending parallel to the mounting surface, a plurality of second wiring portions extending parallel to the mounting surface and along the first direction and arranged in parallel in the second direction on a side farther from the mounting surface than the first wiring portions, and a plurality of pairs of pillar portions extending from both end portions of each of the plurality of second wiring portions toward the mounting surface along a third direction orthogonal to the first direction and the second direction, both end portions of the coil conductor extend to the mounting surface and connected to the pair of terminal electrodes,
wherein at least one of the first wiring portion, the second wiring portion, and the pillar portion of the coil conductor includes a divided portion divided into a plurality of paths in parallel to an extending direction of the divided portion.

2. The coil component according to claim 1, wherein the pillar portion includes the divided portion.

3. The coil component according to claim 2, wherein part of the pillar portion is the divided portion.

4. The coil component according to claim 2, wherein the divided portion of the pillar portion is divided into four paths.

5. The coil component according to claim 3, wherein the divided portion of the pillar portion is divided into four paths.

6. The coil component according to claim 1, wherein at least one of the first wiring portion and the second wiring portion includes the divided portion.

7. The coil component according to claim 1, wherein each of the first wiring portion, the second wiring portion, and the pillar portion includes the divided portion.

8. The coil component according to claim 7, wherein the number of paths of the divided portion of the pillar portion differs from the number of paths of the divided portions of the first wiring portion and the second wiring portion.

9. The coil component according to claim 8, wherein the number of paths of the divided portion of the pillar portions is greater than the number of paths of the divided portions of the first wiring portion and the second wiring portion.

10. The coil component according to claim 1, wherein the element body has a laminated structure including a plurality of insulating layers laminated along the third direction.
